(19) United States
(12) Patent Application Publication
(10) Pub. No.: US 2017/0060511 A1
(43) Pub. Date: Mar. 2, 2017

(54) PORTABLE DRAWING DISPLAY DEVICE AND DRAWING DISPLAY SYSTEM

(71) Applicant: OKI Data Infotech Corporation, Chiba-shi (JP)

(72) Inventor: Masayuki NAGASHIMA, Chiba-shi (JP)

(21) Appl. No.: 15/241,669

(22) Filed: Aug. 19, 2016

(30) Foreign Application Priority Data
Aug. 26, 2015 (JP) 2015-167171

(51) Int. Cl. G06F 3/14; G06T 3/40; G06F 17/30; G06T 3/00

(52) U.S. Cl. CPC G06F 3/1407; G06T 3/0012; G06T 3/40; G06F 17/30268; G06T 11/203

(57) ABSTRACT

A potable drawing display device downloads, from a drawing database, drawing data and a thumbnail of the drawing data, and displays the drawing data and the thumbnail in a display screen. The potable drawing display device includes a communication device that communicates with the drawing database; a drawing data storage device that stores the drawing data and the thumbnail; a screen information storage device that stores display screen information including pixel density information of the display screen; and a drawing data conversion device that generates the thumbnail corresponding to the display screen information and the display screen information. The thumbnail generated by the drawing data conversion device is stored in association with the drawing data stored in the drawing data storage device and corresponds to the generated thumbnail, and the generated thumbnail and the display screen information are transmitted to the drawing database via the communication device.

### CROSS REFERENCE TO RELATED APPLICATION

This application claims priority under 35 USC 119 to Japanese Patent Application No. 2015-167171 filed on Aug. 26, 2015, the entire contents which are incorporated herein by reference.

### TECHNICAL FIELD

The present invention relates to a potable drawing display device and a drawing display system that allow display data that is created by reducing drawing data of a design drawing or the like at a predetermined reduced scale to be displayed in a potable terminal device that is provided with a display screen.

### BACKGROUND

Conventionally, in a construction site, a civil engineering work site and the like, a drawing printed on a sheet of paper is used. Using the drawing, a user performs confirmation of the drawing, revision of a corrected portion, dimension measurement and the like. However, when the number of sheets of drawings to be used is large, the burden on the user side such as carrying the drawings is increased. Further, when the user revises a drawing using a writing instrument, an operation to modify the drawing data of the revised portion using CAD is required later, and a time different occurs between when the revision is made and when the revision is reflected in the drawing data of CAD. In this away, when drawings printed on sheets of paper are used, the burden on the user side is large.

Therefore, a technology is drawing attention in which drawing data that is for printing on a sheet of paper and is managed using a drawing database or the like is used using a terminal device such as a portable personal computer or a tablet terminal device that can be easily carried.

For example, in an invention described in Japanese Patent Laid-Open Publication No. 2013-73604, a device is disclosed that allows drawing data for printing on a sheet of paper prepared using CAD or the like to be managed using a drawing database and allows the drawing data to be displayed at a reduced scale when necessary on a display tablet terminal device that is connected via a network.

Further, in an invention described in Japanese Patent Laid-Open Publication No. 2002-16969, a portable information terminal is disclosed that allows an image of an appropriate size to be generated and displayed in a small display screen with respect to a received image. For example, when a plurality of images are received and stored, in a thumbnail image display mode, the images at a reduced scale can be simultaneously displayed.

### RELATED ART

[Patent Literature 1] Japanese Patent Laid-Open Publication No. 2013-73604.

[Patent Literature 2] Japanese Patent Laid-Open Publication No. 2002-16969.

However, when a thumbnail of a digital drawing is managed using a drawing database or the like, it is possible that a size of the thumbnail is not an appropriate size for a screen of a terminal device in which the thumbnail is actually displayed. There are various terminal devices such as a mobile phone, a tablet terminal and a notebook PC, and sizes of their display screens may be different. Further, even when the sizes of the display screens are the same, when their numbers of pixels are different, the thumbnail may be too small or too large in some cases. Visibility and operability for a user may deteriorate.

Further, when a terminal device downloads a digital drawing registered in a drawing database and creates and displays a thumbnail, when the size of the digital drawing is large, it may take a long time to download. Further, when the number of digital drawings to be downloaded is large, the time it takes to download the digital drawings increases accordingly. Further, it also takes a long time to create thumbnails. The user desires to shorten the download time and reduce the load on the terminal device side.

### SUMMARY

The present invention provides a drawing display device that allows a suitable thumbnail to be used even when terminals having different display screen sizes are used.

A potable drawing display device, disclosed in the application, that downloads, from a drawing database that stores a plurality of digital drawings, drawing data and a thumbnail of the drawing data, and displays the drawing data and the thumbnail in a display screen, the potable drawing display device includes: a communication device that communicates with the drawing database; a drawing data storage device that stores the drawing data and the thumbnail that are received via the communication device; a screen information storage device that stores display screen information including pixel density information of the display screen; and a drawing data conversion device that generates the thumbnail corresponding to the display screen information of the drawing data based on the drawing data that is stored in the drawing data storage device and the display screen information that is stored in the screen information storage device. Wherein the thumbnail that is generated by the drawing data conversion device is stored in association with the drawing data that is stored in the drawing data storage device and corresponds to the generated thumbnail, and the generated thumbnail and the display screen information are transmitted to the drawing database via the communication device.

A drawing display system, disclosed in the application, that includes a drawing database and a potable drawing display device, the drawing database includes: a storage device that stores, in association with each other, drawing data, a thumbnail corresponding to the drawing data, and display screen information corresponding to the drawing data; and a first communication device that communicates with other devices, the potable drawing display device, includes: a second communication device that communicates with the drawing database; a drawing data storage device that stores the drawing data and the thumbnail that are received from the drawing database via the second communication device; a display screen that displays the drawing data and the thumbnail; a screen information storage device that stores the display screen information including pixel density information of the display screen; and a drawing data conversion device that generates the thumbnail corresponding to the display screen information of the drawing data based on the drawing data stored in the drawing data storage device and the display screen information stored in the screen information storage device. Wherein in a case where the thumbnail that is generated by the drawing data conversion device and corresponds to the display screen information of the drawing data and the display screen information that is stored in the screen information storage device are transmitted from the potable drawing display device via the second communication device to the drawing database, and the transmitted thumbnail and display screen information are received by the drawing database via the first communication device, and when the received thumbnail corresponding to the display screen information of the drawing data has not been stored in the storage device of the drawing database in association with the drawing data, the storage device of the drawing database updates the drawing database by adding the received thumbnail and display screen information in association with the drawing data.

According to the present invention, a thumbnail of a suitable size can always be displayed according to a display screen of a terminal on which a drawing is displayed, and a user can use the thumbnail of a suitable size and an operation can be easily performed.

### BRIEF DESCRIPTION OF THE DRAWINGS

FIG. 1 describes a configuration of a drawing display system.

FIG. 2 describes an example of a configuration of a drawing server.

FIG. 3 describes an example of a configuration of a tablet terminal device.

FIG. 4 describes an example of a configuration of a terminal device that registers a drawing in the drawing server.

FIG. 5 describes an example of a display of the tablet terminal device.

FIG. 6 describes an example of a thumbnail.

FIG. 7 is a flow diagram describing an operation of the tablet terminal device.

### DETAILED DESCRIPTION OF THE EMBODIMENTS

An embodiment is described using the drawings.

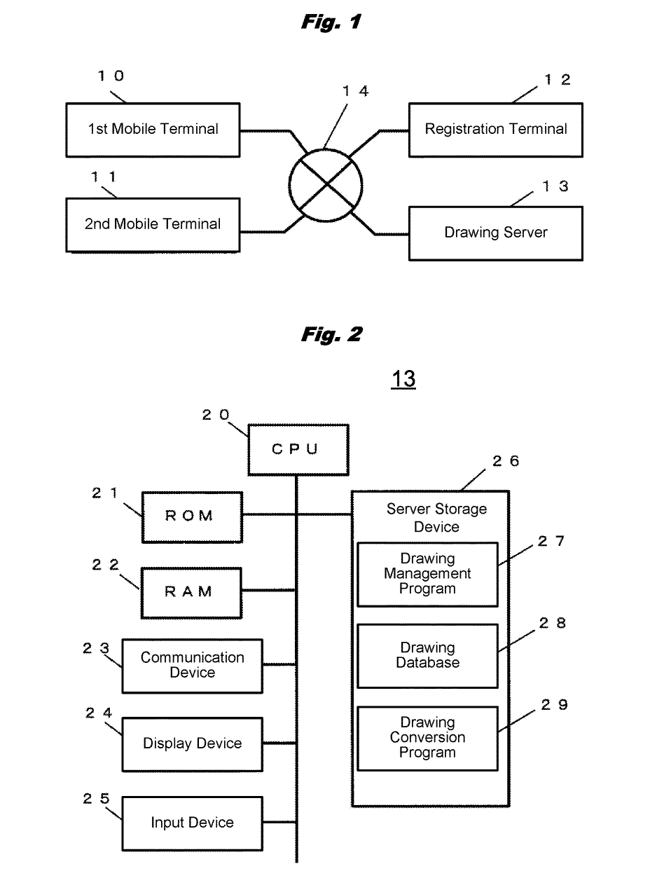

FIG. 1 describes a configuration of a drawing display system. For example, a first mobile terminal 10 or a second mobile terminal 11 is a tablet terminal device. The tablet terminal device can select a digital drawing of a design drawing, and can download the selected digital drawing from a drawing server 13, and can display the downloaded digital drawing.

When a digital drawing is displayed, first, a list of items including a thumbnail, a file name and a keyword is displayed, and next, a user selects a desired one from the list. A digital drawing corresponding to a selected file name can be accurately displayed on a display screen of the tablet terminal device. When a digital drawing is not stored in the tablet terminal device, the tablet terminal device downloads the digital drawing from the drawing server 13, which stores the digital drawing, and displays the digital drawing.

The tablet terminal device for displaying a digital drawing of a design drawing or the like is capable of transmitting and receiving various kinds of data to or from the drawing server 13 via a network such as the Internet 14. The tablet terminal device is thin and relatively light and thus is suitable for being hand-carried and is particularly convenient for being brought to, for example, a construction site, a civil engineering work site, a survey site, and the like.

Further, a digital drawing of a design drawing or the like is created using drawing software such as CAD, and is registered in the drawing server 13 using a registration terminal 12. In this case, the digital drawing is registered with associated file information including a thumbnail, a file name, and a keyword.

FIG. 2 describes an example of a configuration of the drawing server. The drawing server 13 has a CPU 20, a ROM 21, a RAM 22, a communication device 23, a display device 24, an input device 25, and a server storage device 26. The ROM 21, the RAM 22, the communication device 23, the display device 24, the input device 25 and the server storage device 26 are controlled by the CPU 20.

The CPU 20 performs information processing and controls the parts of the drawing server 13 according to a program stored in the ROM 21. The ROM 21 is a memory that stores a program or a parameter for the drawing server 13 to operate. The RAM 22 is a working memory, a memory that provides an area to temporarily store data when the CPU 20 performs management processing of drawing data, performs computing, and the like.

The communication device 23 is a device that connects the drawing server 13 to a network such as the Internet 14 and performs communication. The drawing server 13 transmits drawing data via the communication device 23 to a tablet terminal device such as the first mobile terminal 10 or the second mobile terminal 11.

The display device 24 has a component for display such as a liquid crystal display, and can display, on a screen, a digital drawing, various instructions during operation, input data, or the like.

The input device 25 is used to input various kinds of data. For example, the tablet terminal device such as the first mobile terminal 10 or the second mobile terminal 11 has a touch panel that includes the display device 24 and the input device 25. Depending on a mode, a keyboard is displayed and a character input is performed by touching a displayed character.

The server storage device 26 has, for example, a mass storage medium such as a hard disk or a flash memory, and stores a drawing management program 27 that manages digital drawings, a drawing database 28 that is a database of drawing data and the like, a drawing conversion program 29 that creates a thumbnail from drawing data, and the like. The drawing database 28 serves as a storage device that stores drawing data and display screen information corresponding to the drawing data in association with each other.

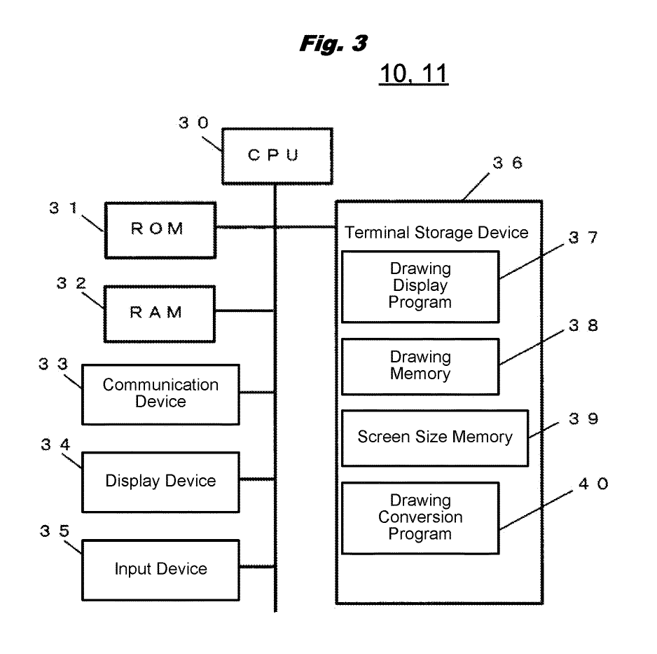

FIG. 3 describes an example of a configuration of the tablet terminal device. An example of a configuration of the first mobile terminal 10 or the second mobile terminal 11 is described using the tablet terminal device. The tablet terminal device has a CPU 30, a ROM 31, a RAM 32, a communication device 33, a display device 34, an input device 35, and a terminal storage device 36. The ROM 31, the RAM 32, the communication device 33, the display device 34, the input device 35 and the terminal storage device 36 are controlled by the CPU 30.

The CPU 30 integrally controls the parts of the tablet terminal device by executing information processing according to various programs such as a drawing display program stored in the ROM 31. The ROM 31 is a memory that stores various programs for the CPU 30 to execute and parameters required by the execution of the programs. The RAM 32 is a working memory, a memory that provides an area to temporarily store data when the CPU 30 performs management processing of drawings, performs computing, and the like.

The display device 34 is a display device such as a liquid crystal display, and can display drawing data of a digital drawing, characters, graphics, and the like. Display density data of a display screen of the display device 34, a value represented by “the number of pixels of the display screen/an actual size of an actual display region of the display screen,” is stored in a screen size memory 39 (to be described later). The display density data includes display density data in vertical and horizontal directions of the display screen, the numbers of pixels in the vertical and horizontal directions, and lengths of the display region of the actual size in the vertical and horizontal directions.

The communication device 33 is connected to a network such the Internet 14 by a wired or wireless connection, and is a communication device for communicating with other devices. Drawing data of a digital drawing and the like are received from the drawing server 13 via the communication device 33.

The communication device 33 functions as a digital drawing acquisition device. However, a digital drawing can also be acquired via other methods. For example, a digital drawing may also be acquired using a memory card such as a USB memory.

The input device 35 is used to input various kinds of data. For example, the input device 35 is a touch panel, and performs input by touching a predetermined area corresponding to a mark or the like displayed on the display device 34.

The terminal storage device 36 has, for example, a mass storage medium such as a hard disk or an EEPROM (Electrically Erasable Programmable ROM), and stores a drawing display program 37 and the like, the drawing display program 37 displaying drawing data by enlarging or reducing the drawing.

By executing the drawing display program 37, the CPU 30 refers to file information such as display density data, drawing data and the like that are included in a received digital drawing, and displays a design drawing at a reduced scale that is selected using the display device 34. Further, in a list display of digital drawings, thumbnails are displayed in the display device 34. Further, the terminal storage device 36 has the screen size memory 39, and stores the display density data of the display device 34.

The display density data may be expressing in units of ppi. Ppi is a value expressed as a number of pixels per inch, and may also be expressed as dpi (a number of dots per inch), and may also be referred to as a resolution of a display screen.

The drawing memory 38 stores a digital drawing, which is acquired by downloading, and file information including a thumbnail, a file name and a keyword associated with the digital drawing. The data stored in the drawing memory 38 is displayed in the display device 34.

The drawing conversion program 40 is a program that generates a thumbnail, at a reduced scale corresponding to the display density data of the display device 34 stored in the screen size memory 39, for drawing data of a digital drawing stored in the drawing memory 38. The display density data of the display device 34 stored in the screen size memory 39 is acquired, and a thumbnail corresponding to the display density data is generated. In the case of list display, a too small or too large thumbnail is difficult for s user to see. Therefore, a thumbnail having a size that matches a screen is generated. The size can be obtained by calculating using a formula that is predetermined based on the display density data. Further, it is also possible that a correspondence table associating a size with the display density data is stored in the program, and a size that matches the display density data is obtained. Further, it is also possible that the size is stored as a parameter in the ROM 31.

The example of the configuration of the first mobile terminal 10 or the second mobile terminal 11 has been described using the tablet terminal device. However, the present invention can also be appropriately applied to various potable terminals such as a notebook computer and a mobile phone that are provided with a function of displaying an image on a display screen.

The terminal storage device 36 is a storage device that stores various kinds of data, and can be used according to a purpose. For example, the drawing memory 38 is used as a drawing data storage device that stores file information of a digital drawing, and the screen size memory 39 is used as a screen information storage device that stores display screen information such as the display density data, the number of pixels and the like of the display device 34.

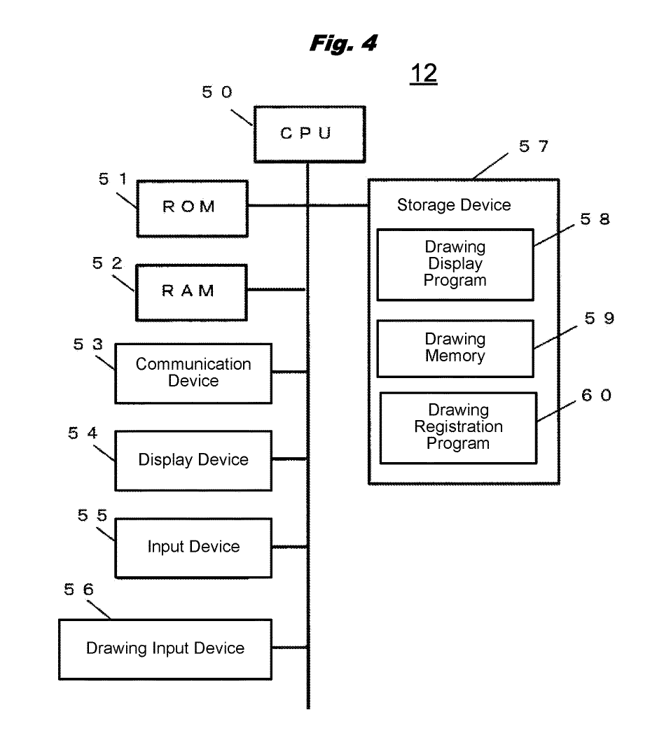

FIG. 4 describes an example of a configuration of the terminal device that registers a drawing in the drawing server. Here, a digital drawing is described. The drawing server 13 has the drawing database 28, which is a database of digital drawings, and the digital drawings are managed and stored in the drawing database 28. A digital drawing has, as components, drawing data for displaying the drawing and attribute information that represents attributes of the drawing data. The attribute information includes: for example, an image size of the digital drawing; a format type; a thumbnail of the digital drawing and the display density data suitable for displaying the thumbnail; a keyword; a file name; and the like. The keyword is a word or a sentence related to the corresponding digital drawing. By searching for the keyword, a digital drawing that is stored in association with the keyword can be acquired. The drawing data of one digital drawing and the attribute information and the like that are stored in association with the drawing data are treated as file information of the one digital drawing.

Further, the drawing data of a digital drawing may be formed of data in a vector format or in a raster format (bitmap format). Formatting data in the raster format is a method in which an image is formed in a bitmap. Formatting data in the vector format is a method in which all data of a drawing that is processed in a computer is managed in numerical values. In the vector method, coordinate data of vertices and the like of a drawing is stored, and each time the drawing is displayed, information about lines that form a contour is expressed by arithmetic processing. Therefore, when a size of a drawing is modified or the drawing is varied, the drawing can be accordingly displayed. Therefore, the vector method is suitable for a design drawing or the like for which modification, variation and the like are frequently performed. Further, the vector method is also suitable for being used in the tablet terminal device in which enlarging or reducing a drawing is frequently performed. It is preferable that a thumbnail be stored in the raster format. As long as a thumbnail is recognizable, it does not matter much even when the thumbnail is somewhat distorted. Therefore, the raster format is more preferable for a thumbnail than the vector method for which a display processing load is large.

The registration terminal 12 has a CPU 50, a ROM 51, a RAM 52, a communication device 53, a display device 54, an input device 55, a drawing input device 56, and a storage device 57. The CPU 50 performs information processing and computing and controls the parts of the registration terminal 12 according to a program stored in the ROM 51. The ROM 51, the RAM 52, the communication device 53, the display device 54, the input device 55, the drawing input device 56 and the storage device 57 are controlled by the CPU 50.

The ROM 51 is a memory that stores a program or a parameter for the registration terminal 12 to operate. The RAM 52 is a working memory, a memory that provides an area to temporarily store data when the CPU 50 performs management processing of drawing data, performs computing, and the like.

The communication device 53 is a device that connects the registration terminal 12 to a network such as the Internet 14 and performs communication. The registration terminal 12 transmits file information including drawing data, a keyword and the like of a digital drawing to the drawing server 13 via the communication device 53, and registers the file information in the drawing server 13.

The display device 54 has a display part such as a liquid crystal display, and can display information such as the registered drawing data, attribute information and the like. The input device 55 is used to input various kinds of data. and includes, for example, a keyboard and a mouse.

The drawing input device 56 is a device that inputs or creates drawing data to be registered. For example, the drawing input device 56 is a CAD device or the like, and can create drawing data. Or, it is also possible that a drawing is scanned using a scanner and data so obtained is used as drawing data. The drawing input device 56 is a device that generates drawing data in this way.

The storage device 57 has, for example, a mass storage medium such as a hard click or a flash memory, and stores: a drawing display program 58 that displays drawing data; a drawing memory 59 that stores file information including drawing data, attribute information and the like to be registered; a drawing registration program 60 that registers, in the drawing database 28, the file information including the drawing data, the attribute information and the like stored in the drawing memory 59; and the like. Further, it is also possible that the storage device 57 stores a drawing conversion program that creates a thumbnail of a predetermined size from drawing data, and creates a thumbnail using the program and associates the thumbnail with the drawing data. When a thumbnail that is stored in association with drawing data does not exist, a thumbnail that is displayed as initial data can be used.

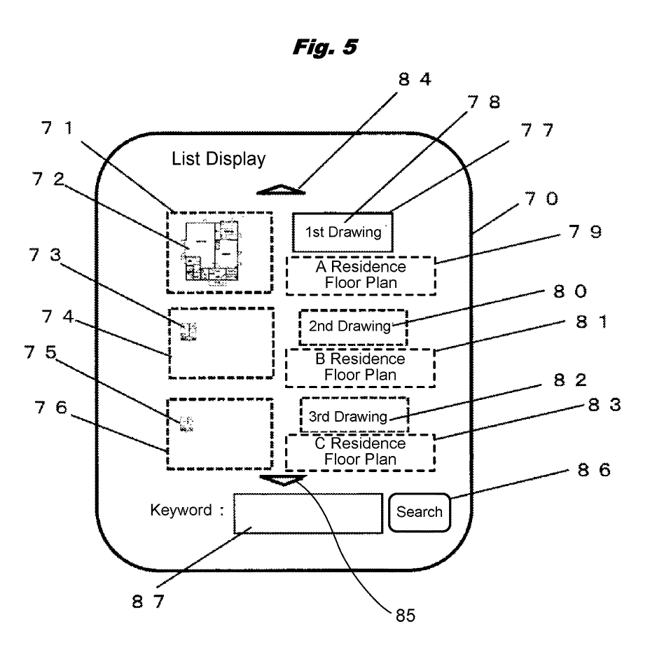

FIG. 5 describes an example of a display of the tablet terminal device. When a list of file information excluding drawing data acquired from the drawing database 28 is displayed, the drawing data is not displayed as-is in place of a thumbnail. A thumbnail is displayed in place of the drawing data. For example, a screen 70 displays three thumbnails in a list display screen. The number of thumbnails that are simultaneously displayed in a list varies depending on the size of the display device 34.

Corresponding to first drawing data, a corresponding thumbnail (here, a first thumbnail 72) is displayed in a first thumbnail display area 71, a corresponding file name (here, a “first drawing”) is displayed in a first file name display area 77, and a corresponding “A Residence Floor Plan” is displayed in a first keyword display area 79. The first file name display area 77 is surrounded by a solid line. This indicates that the first drawing is selected. The selection can be done by touching the area.

Similarly, corresponding to second drawing data, a corresponding thumbnail (here, a second thumbnail 73) is displayed in a second thumbnail display area 74, a corresponding file name (here, a “second drawing”) is displayed in a second file name display area 80, and a corresponding “B Residence Floor Plan” is displayed in a second keyword display area 81. Similarly, corresponding to third drawing data, a corresponding thumbnail (here, a third thumbnail 75) is displayed in a third thumbnail display area 76, a corresponding file name (here, a “third drawing”) is displayed in a third file name display area 82, and a corresponding “C Residence Floor Plan” is displayed in a third keyword display area 83. The first thumbnail 72 displayed in the first thumbnail display area 71 has a good thumbnail size and is easily visible. However, the second thumbnail 73 and the third thumbnail 75 have small sizes and are hardly visible. With respect to a given screen size, a thumbnail having a good size is necessary. As for an example of displaying a thumbnail that does not correspond to the display device 34 to be used, that is a case where only thumbnails in predetermined sizes have been registered, which were created at a timing when the file information was registered by the registration terminal 12. When no thumbnail exists that does not accord with the display density data of the display device 34 to be used, the registered thumbnail is displayed as an initial value. Also, when no thumbnail exists that falls within a range of the display density data, the registered thumbnail may be displayed as the initial value. The range is regarded as a predetermined range with respect to the display density data of the display device 34 to be used, for example plus or minus 10%, in which an influence to the display is small.

When the list display includes four or more thumbnails, by operating a first scroll button 84 or a second scroll button 85, the display can be scrolled and the list can be sequentially displayed. By touching a keyword input part 87, a keyboard pops up, thereby allowing keyword input. By touching a search button 86, drawing data having the input keyword as attribute information is searched from a list, and a list of search results is displayed on the screen.

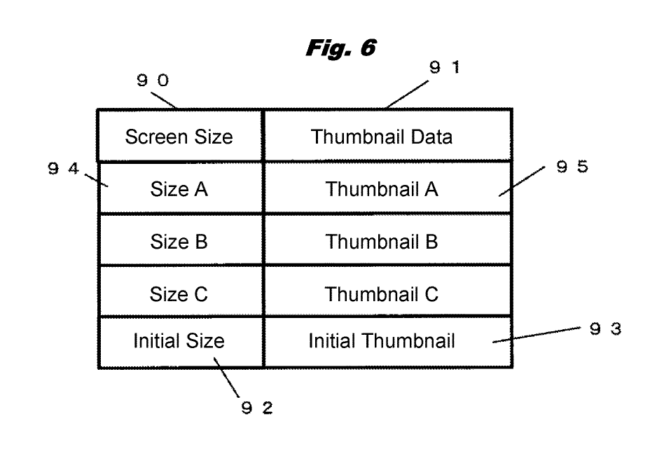

FIG. 6 describes an example of a thumbnail. For various screen sizes, it is necessary to create thumbnails having sizes suitable for the screen sizes. The created thumbnails of different sizes are stored in association with drawing data and display density data. FIG. 6 conceptually illustrates that a screen size column 90 in a first column stores the display density data, and a thumbnail data column 91 in a second column stores data of the thumbnails corresponding to the display density data. For example, a thumbnail corresponding to a size A 94 is a thumbnail A 95. Further, in the drawing server 13, when a thumbnail is not generated, a thumbnail of an initial value is generated. An initial thumbnail 93 of the initial value is stored in association with an initial size 92 that is a predetermined standard screen size.

Display devices of various screen sizes and resolutions are used in mobile terminals using drawing data. Therefore, various thumbnails and various kinds of display density data are stored in the drawing database 28 in association with the drawing data. A mobile terminal using the drawing data selects a most suitable thumbnail to download and use according to the display device of the mobile terminal, that is, according to the display density data of the mobile terminal.

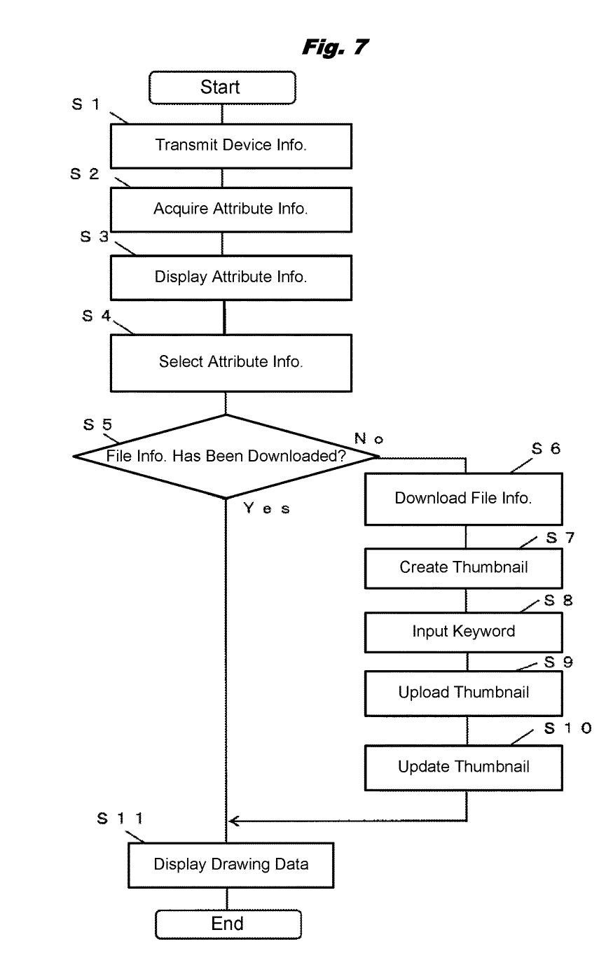

FIG. 7 is a flow diagram describing an operation of the tablet terminal device according to the present embodiment. First, when the drawing data stored in the drawing server 13 is used, for example, by the first mobile terminal 10, it is necessary to display, in the display device 34, drawing data that can be used by the first mobile terminal 10. Therefore, first, the attribute information of the file information of all the drawing data that can be used is acquired. At S1, prior to acquiring the attribute information of the file information, device information about the first mobile terminal 10 is transmitted to the drawing server 13. The device information includes information about the display density data of the display device 34. Further, by including a unique device ID, the mobile terminal using the drawing data can be identified.

Upon receiving the device information, the drawing server 13 acquires information about the display density data of the display device 34. As an item included in the attribute information of the file information of the drawing data, an accompanying thumbnail is selected based on the acquired display density data. When a corresponding thumbnail does not exist, the initial thumbnail 93 is selected. Further, when the unique device ID is acquired, only the attribute information of the file information of the drawing data that can be used by the unique device ID is selected.

The selection of the attribute information of the drawing data that is used by the connected first mobile terminal 10 is completed, and all of the file information is extracted. The attribute information of the extracted file information is transmitted to the first mobile terminal 10. The first mobile terminal 10 acquires the attribute information of the file information (S2).

Next, at S3, the acquired attribute information of the file information is listed in the display device 34. For example, as illustrated in FIG. 5, a list is displayed in the screen. The attribute information of the file information includes a file name, a thumbnail and a keyword, and these are displayed. In this case, when there is a thumbnail suitable for the display density data, the thumbnail is preferably displayed. For example, with respect to the first thumbnail display area 71 in FIG. 5, the first thumbnail 72 is displayed over substantially the entire area. Further, when an initial thumbnail that is different from the display density data is acquired, the thumbnail is displayed too small. For example, with respect to the second thumbnail display area 74 in FIG. 5, the second thumbnail 73 is displayed in a small area in an upper left corner, which is about 15% of the second thumbnail display area 74. This means that the number of pixels of the thumbnail is significantly smaller than the number of pixels of the display area. Even when the visibility of the thumbnail is poor, a user can determine, from the file name, keyword or the like, whether or not the drawing data is what the user desired. However, when the visibility of the thumbnail is good, the user can easily determine whether or not the drawing data is what the user desired.

Next, at S4, from the list display, the desired drawing data is selected. For example, by touching the first scroll button 84 and the second scroll button 85 in FIG. 5, file information that is not displayed can be displayed. Further, by inputting a keyword and touching the search button 86, attribute information of drawing data corresponding to the keyword can be searched and displayed. By using such a function, from a plurality of items, a desired one can be found. When attribute information of file information corresponding to the desired drawing data is founded, the desired drawing data is specified by touching the screen. By continuously touching twice, the specified file information is selected, and the processing proceeds to the next step.

Next, at S5, whether or not the file information that includes the selected desired drawing data has been downloaded is determined. Whether or not the file information has been downloaded can be determined based on whether or not the file information is stored in the drawing memory 38. When the file information has been downloaded, the processing proceeds to S11. Otherwise, the processing proceeds to S6. At S6, the file information that includes the selected desired drawing data is downloaded from the drawing database 28 of the drawing server 13.

For example, in the drawing memory 38, the file information that includes thumbnails obtained by download and the display density data corresponding to the thumbnails etc. is stored. Also, in the drawing size memory 39, the display drawing information that includes the display density data of display device 34, the number of pixels etc. is stored. The display density data corresponding to the downloaded thumbnail is compared with the display density data stored in the drawing size memory 39. When the display density data corresponding to the downloaded thumbnail accords with or falls with in a predetermined range (for example ±10%) in which the influence to the display is regarded small, the thumbnail is displayed. It is more preferred that, when the display density data accords with it, the thumbnail is displayed. On the other hand, when the display density data does not accord with it, or does not fall within that predetermined range, a new thumbnail is created. It is more preferred that, when the display density data does not accord with it, the new one is created. When the thumbnail is created, it proceeds to S7.

Next, at S7, when a thumbnail corresponding to the display density data of the display device 34 of the first mobile terminal 10 does not exist, it is necessary to create the corresponding thumbnail. Based on the downloaded drawing data, the thumbnail corresponding to the display density data is created using the drawing conversion program 40. Next, at S8, when the thumbnail has been created, a keyword is input and is stored in the RAM 32. Next, at S9, when the thumbnail has been created, the created thumbnail is stored in the drawing database 28 in association with the created original drawing data (or upload the thumbnail). In this case, the created thumbnail is stored also in association with the display density of the display device 34 of the first mobile terminal 10.

For example, the thumbnail is created by compressing the original drawing so that the number of pixel in the lateral direction becomes 25% in size. Like this way, the thumbnail becomes a predetermined sized drawing corresponding to the display device 34. The pixels in the longitudinal direction are compressed with a compression rate that corresponds to the compression rate in the lateral direction. Also, the original drawing may be compressed so that the number of pixels becomes a predetermined number, for example 100 pixels.

Various methods for compression are available. For example, it is considered where the sizes of the original drawing are 1000 pixels in the lateral direction and 500 pixels in the longitudinal direction and the compression rate is 1% in size. In general, 1% in size means a thumbnail having 100 lateral pixels and 50 longitudinal pixels. The original image is equally divided into 100 segments in the lateral direction and 50 segments in the longitudinal direction so that new areas are grouped. Namely, each of the areas is lateral 10 pixels and longitudinal 5 pixels. By averaging several pixels in each of the arears, new one pixel data is created. This is one example. There are various ways to compact original drawings into predetermined sized ones.

Next, the thumbnail of the file information that is used in the list display is updated to the newly created thumbnail (S10). That is, the data stored in the drawing memory 38 is updated. As a result, when a list is displayed next time, the thumbnail having a size corresponding to the display area is displayed.

Next, at S11, the selected drawing data is displayed in the screen. In this way, when a thumbnail suitable for the first mobile terminal 10 is not stored in the drawing database 28, the first mobile terminal 10 generates a suitable thumbnail from drawing data, and thereafter, uploads the generated thumbnail and display density data in association with the drawing data of the drawing database 28. For example, when the display density of the second mobile terminal 11 is the same as that of the first mobile terminal 10, when file information of the drawing data is acquired, a suitable thumbnail can be acquired.

For example, when the display density data of the first mobile terminal 10 is 100 PPI and the display density data of the second mobile terminal 11 is 200 PPI and when the screen sizes of the first mobile terminal 10 and the second mobile terminal 11 are the same, the size of the display in the first mobile terminal 10 is twice that of the display in the second mobile terminal 11. In this way, the display changes depending on a terminal. Therefore, a display that matches a terminal is necessary.

It is not that the drawing server 13 always creates a thumbnail having a suitable size for each of a variety of display devices. When a terminal to be used uses the drawing data for the first time, a thumbnail is created and is stored in the drawing server 13. That is, when a suitable thumbnail does not exist in the drawing server 13, a thumbnail is created based on the downloaded drawing data and the display density data of the device, and the thumbnail is added and stored in association with drawing data in the drawing database 28. From the next time, when the thumbnail of the file information is acquired, a suitable thumbnail can be acquired. When a user uses a terminal device to use drawing data, each time when a suitable thumbnail does not exist, a thumbnail is created. Accumulation of thumbnails having sizes that are not used does not occur. Therefore, only thumbnails having sizes that are needed are stored in the drawing server 13 in association with drawings.

Since it is not that the drawing server 13 acquires the display density of the terminal to be used and creates a thumbnail corresponding to the display density, required thumbnails can be increased without increasing a processing load of the drawing server 13. However, it is also possible that processing capability of a terminal device that is used by a user is significantly low. In this case, it is possible that, when a tablet terminal device acquires file information from the drawing server 13, the tablet terminal device instructs the drawing server 13 to creates a thumbnail, a thumbnail corresponding to the display density data of the tablet terminal device is created using the drawing conversion program 29 of the drawing server 13 and is stored in the drawing database 28, and file information containing the created thumbnail is transmitted to the tablet terminal device. Since it is not that thumbnails are created for a large number of drawing data sets, the load of the drawing server 13 is also reduced.

The present invention can be applied to a tablet-type portable terminal device. The display density data discussed above is an example of pixel density information of the present invention.

What is claimed is:

1. A potable drawing display device that downloads, from a drawing database that stores a plurality of digital drawings, drawing data and a thumbnail of the drawing data, and displays the drawing data and the thumbnail in a display screen, the potable drawing display device, comprising:
a communication device that communicates with the drawing database;
a drawing data storage device that stores the drawing data and the thumbnail that are received via the communication device;
a screen information storage device that stores display screen information including pixel density information of the display screen; and
a drawing data conversion device that generates the thumbnail corresponding to the display screen information of the drawing data based on the drawing data that is stored in the drawing data storage device and the display screen information that is stored in the screen information storage device, wherein
the thumbnail that is generated by the drawing data conversion device is stored in association with the drawing data that is stored in the drawing data storage device and corresponds to the generated thumbnail, and
the generated thumbnail and the display screen information are transmitted to the drawing database via the communication device.

2. The potable drawing display device according to claim 1, wherein
a keyword corresponding to the drawing data is stored in the drawing database in associating with the drawing data, and,
when the keyword corresponding to the drawing data is received via the communication device, the thumbnail and the keyword that correspond to the drawing data are both displayed in the display screen.

3. A drawing display system that includes a drawing database and a potable drawing display device,
the drawing database, comprising:
a storage device that stores, in association with each other, drawing data, a thumbnail corresponding to the drawing data, and display screen information corresponding to the drawing data; and
a first communication device that communicates with other devices,
the potable drawing display device, comprising:
a second communication device that communicates with the drawing database;
a drawing data storage device that stores the drawing data and the thumbnail that are received from the drawing database via the second communication device;
a display screen that displays the drawing data and the thumbnail;
a screen information storage device that stores the display screen information including pixel density information of the display screen; and
a drawing data conversion device that generates the thumbnail corresponding to the display screen information of the drawing data based on the drawing data stored in the drawing data storage device and the display screen information stored in the screen information storage device, wherein
in a case where the thumbnail that is generated by the drawing data conversion device and corresponds to the display screen information of the drawing data and the display screen information that is stored in the screen information storage device are transmitted from the potable drawing display device via the second communication device to the drawing database, and the transmitted thumbnail and display screen information are received by the drawing database via the first communication device, and
when the received thumbnail corresponding to the display screen information of the drawing data has not been stored in the storage device of the drawing database in association with the drawing data, the storage device of the drawing database updates the drawing database by adding the received thumbnail and display screen information in association with the drawing data.
